(19) United States
(12) Patent Application Publication
(10) Pub. No.: US 2008/0034144 A1
(43) Pub. Date: Feb. 7, 2008

(54) DUAL-INTERFACE COMPUTER INTERFACE CARD

(75) Inventors: Bo - Hong Lin, Hsin-Chu (TW); Yu - Ming Tseng, Hsin-Chu (TW); Bo - Cheng Chen, Hsin-Chu (TW)

Correspondence Address: BROWDY AND NEIMARK, P.L.L.C.;624 NINTH STREET, NW, SUITE 300, WASHINGTON, DC, 20001-5303, US

(73) Assignee: Billionton Systems Inc., Hsin-Chu (TW)

(21) Appl. No.: 11/770,848

(22) Filed: Jun. 29, 2007

(30) Foreign Application Priority Data
Aug. 3, 2006 (TW) 95213685

(51) Int. Cl. G06F 13/00

(52) U.S. Cl. 710/302

(57) ABSTRACT

A dual-interface computer interface card includes a circuit board. The circuit board includes an ExpressCard connector, a USB connector, a control circuit, a converter, two USB signal traces, two DC traces. The two USB traces are electrically connected with the ExpressCard connector and the USB connector respectively. The two DC traces are electrically connected with the converter and respectively with the ExpressCard and USB connectors. The control circuit, subject to the required DC operation voltage, is optionally connected with one of the two DC traces, while another DC trace is connected with the converter to convert its DC voltage level into the DC voltage level required by the control circuit. Accordingly, the computer interface card can be connected with the computer system optionally by one of the connectors thereof for transmission of USB signals therebetween.

### BACKGROUND OF THE INVENTION

1. Field of the Invention

The present invention relates generally to computer peripherals and more particularly, to a dual-interface computer interface card capable of hot plug.

2. Description of the Related Art

As the information technology (IT) advances by leaps and bounds, the cybernetic devices need to meet diverse requirements not only by basic built-in hardware but also by a variety of peripheral devices. Particularly, the portable devices which are compatible with most of the computer systems and capable of hot plug, like wireless communication apparatuses, e.g. wireless network or Bluetooth devices, or mass storage memory devices, can fulfill compactness, convenience, practicality, and diversification required by the IT products. In addition, the desktop and laptop computers and the personal digital assistants (PDA) are more and more popular, such that the suppliers of the computer peripherals are led to ceaseless development and breakthrough of the portable devices compatible with each computer system.

Currently, universal serial bus (USB) is the mainstream connection technology of peripheral interface, and the peripherals having USB interface keep developed one by one. Even the Personal Computer Memory Card International Association (PCMCIA), which first developed PCMCIA interface, also developed and proposed a new ExpressCard interface in 2003, which is the combination of USB and PCI (peripheral component interconnection) Express for enhancing transmission velocity and bandwidth, attaining connection convenience, and reducing the system cost, thus having characteristics of broadband transmission of USB and high-efficiency operation of PCI Express. In addition, the USB 2.0 interface technology which is downward compatible with USB 1.1 and USB 1.0 is combined in the ExpressCard. Accordingly, the ExpressCard is compatible with the general notebook and desktop computers to become the high-speed serial bus interface.

For the desktop computer, however, the ExpressCard fails to directly plug into the USB port exposed outside the general computer but has to employ particular card readers for connection with the USB host controller of the computer system. One kind of the employed ExpressCard readers is a portable card reader having USB interface to make the interface conversion between the ExpressCard and the USB port of the computer system. Another kind of the employed ExpressCard readers is a built-in card reader in the computer system which accesses the peripheral interface compatible with the ExpressCard. However, the former is an additional portable device of the card reader and the latter needs extra hardware space inside the computer system for installation of the card reader, such they both fail to be casually and effectively applied to the current computer system. In addition, the ExpressCard interface defines direct current (DC) power requirement of 1.5/3.3V, that is different from the 5V DC power of standard USB interface. Therefore, the USB control chip in the ExpressCard could only be particularly designed with 3.3V DC operation, and the general control chips compatible with the standard USB interface fail to be applied to the ExpressCard, thus narrowing the scope of the application of the ExpressCard.

### SUMMARY OF THE INVENTION

The primary objective of the present invention is to provide a dual-interface computer interface card, which is characterized in the dual interfaces of ExpressCard and USB compatible with various computer systems.

The foregoing objective of the present invention is attained by the dual-interface computer interface card is composed of a housing and a circuit board mounted in the housing.

The circuit board includes an ExpressCard connector, a USB connector, a control circuit, a converter, two USB signal traces, a first DC trace, and a second DC trace. The ExpressCard connector is provided for plugging into a built-in ExpressCard slot of a notebook or general computer. The USB connector is provided for plugging into a USB port of the general computer system. The two USB traces are coupled with each other and electrically connected with the ExpressCard connector and the USB connector respectively. The first DC trace is electrically connected with the ExpressCard connector and the converter for transmitting 3.3V DC power supplied by the notebook or general computers via the ExpressCard interface. The second DC trace is electrically connected with the USB connector and the converter for transmitting 5V DC power supplied by the USB interface of the general computer system. The control circuit includes a USB signal terminal and a power terminal. The USB signal terminal is electrically connected with the two USB signal traces. The power terminal is selectively connected with one of the two DC traces according to the required DC operation voltage of the control circuit, while another DC trace is connected with the converter to convert its DC voltage level into the DC operation voltage required by the control circuit.

In light of the above, the ExpressCard connector is designed as the standard structure of ExpressCard interface for compatibility with the ExpressCard slot in the computer, while the USB connector can be designed in various portable structures of USB interface for connection with various computer systems respectively. Therefore, either of the connectors of the dual-interface computer interface card is selectively for transmission of USB signals with the computer system. In addition, the control circuit can be optionally adopted with various application of DC operation voltage. When the control circuit requires 3.3V for the DC operation voltage, the power terminal is electrically connected with the first DC trace and the converter functions as converting the voltage level (5V) of the second DC trace into the voltage level (3.3V) of the first DC trace. When the control circuit requires 5V for DC operation voltage, the power terminal is electrically connected with the second DC trace and the converter functions as converting the voltage level (3.3V) of the first DC trace into the voltage level (5V) of the second DC trace.

### BRIEF DESCRIPTION OF THE DRAWINGS

FIG. 1A is a schematic view of a first preferred embodiment of the present invention, illustrating the appearance of the connector of the ExpressCard interface.

FIG. 1B is another schematic view of the first preferred embodiment of the present invention, illustrating the appearance of the connector of the USB interface.

FIG. 2 is another schematic view of the first preferred embodiment of the present invention, illustrating that the circuit board is mounted in the housing.

FIG. 3 is a circuit diagram of the circuit board of the first preferred embodiment of the present invention.

FIG. 4 is a circuit diagram of the control circuit of the first preferred embodiment of the present invention.

FIG. 5 is a circuit diagram of the circuit board of a second preferred embodiment of the present invention.

FIG. 6 is a circuit diagram of the circuit board of the second preferred embodiment of the present invention.

FIG. 7 is a schematic view of a third preferred embodiment of the present invention, illustrating the appearance of the connector of the mini USB interface.

FIG. 8 is a schematic view of a fourth preferred embodiment of the present invention, illustrating the appearance of the signal wires disposed on the circuit board.

FIG. 9 is a schematic view of a fifth preferred embodiment of the present invention, illustrating the appearance of the USB terminal in connection with the USB plug.

FIG. 10 is another schematic view of the fifth preferred embodiment of the present invention, illustrating the appearance of the USB plug.

FIG. 11 is another schematic view of the fifth preferred embodiment of the present invention, illustrating that the USB plug is received in the slot of the housing.

### DETAILED DESCRIPTION OF PREFERRED EMBODIMENTS

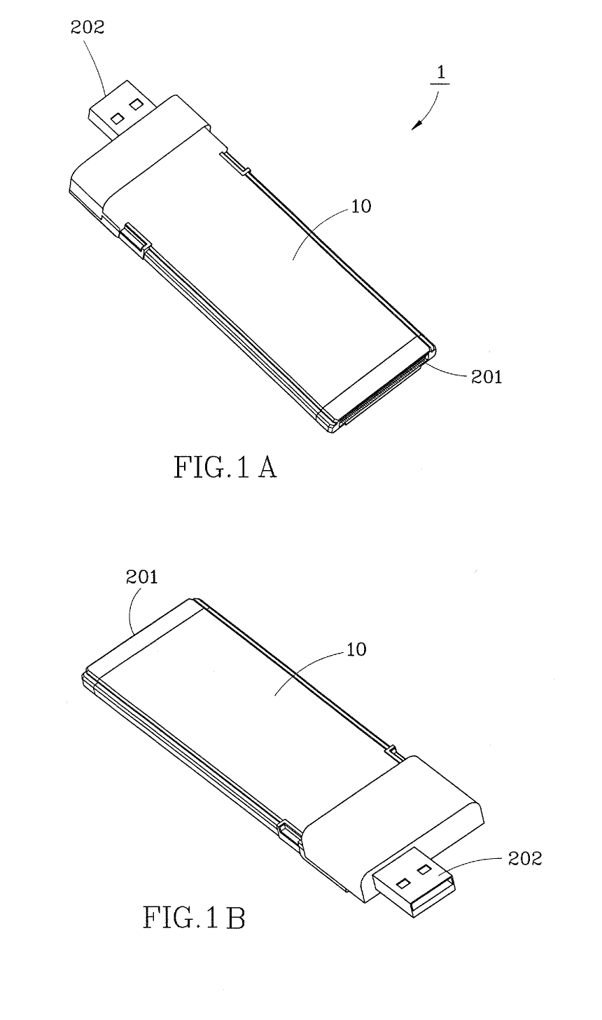

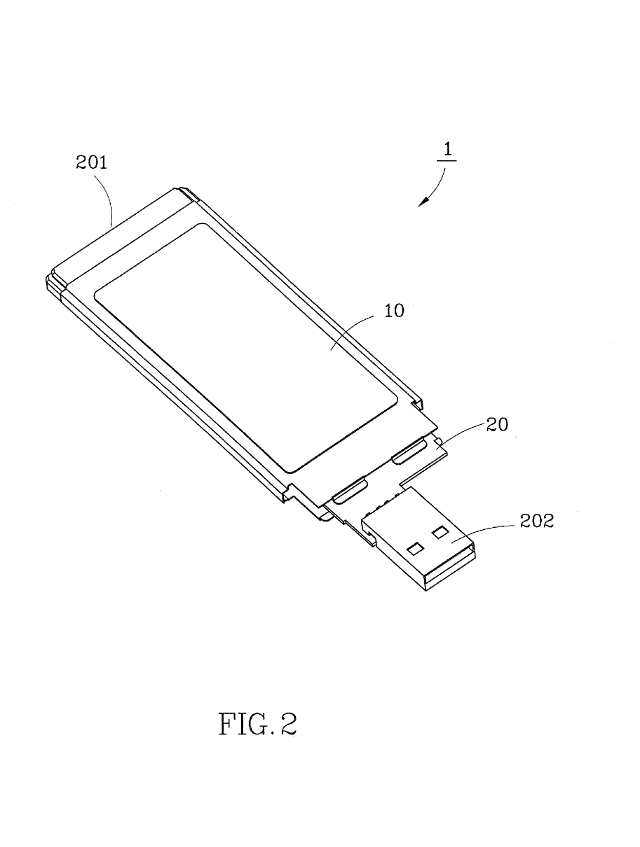

Referring to FIGS. 1-3, a dual-interface computer interface card 1 constructed according to a first preferred embodiment of the present invention is composed of a housing 10 and a circuit board 20 mounted in the housing 10. The circuit board 20 includes an ExpressCard connector 201, a USB connector 202, a converter 21, a control circuit 22, two USB signal traces 23 and 24, a first DC trace 25, and a second DC trace 26.

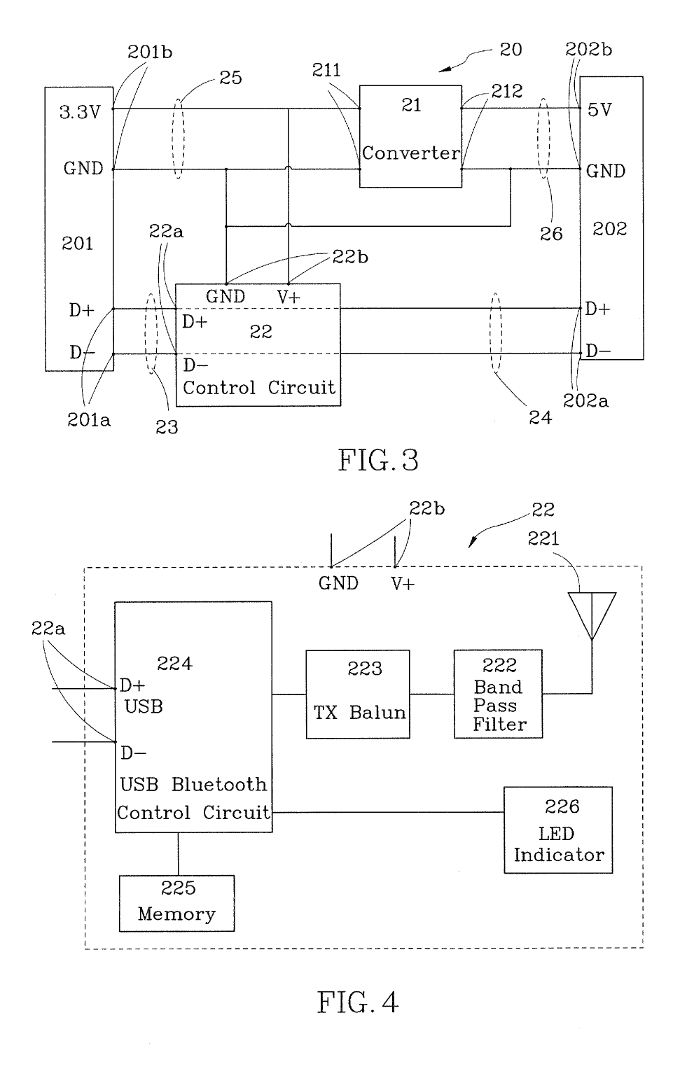

The ExpressCard connector 201 is a standard structure of ExpressCard interface for plugging into an ExpressCard slot of a notebook computer (not shown) or a general computer system (not shown). As shown in FIG. 3, the ExpressCard connector 201 has a USB signal terminal 201a (D+, D−) and a power terminal 201b (3.3V, GND) which are electrically connected with the USB signal trace 23 and the first DC trace 25 respectively.

The USB connector 202 is a standard USB plug in this embodiment for plugging into a USB port (not shown) of the general computer system. As shown in FIG. 3, the USB connector 202 has a USB signal terminal 202a (D+, D−) and a power terminal 202b (5V, GND), which are electrically connected with the USB signal trace 24 and the second DC trace 26 respectively.

The converter 21 includes a first DC terminal 211 and a second DC terminal 212, which are electrically connected with the first and second DC traces 25 and 26 respectively. The converter 21 functions as converting the voltage level (5V) of the second DC trace 26 into the voltage level (3.3V) of the first DC trace 25. In this embodiment, the converter 21 is a chip (No. XC6204) produced by TOREX SEMICONDUCTOR LTD. located in Japan.

The control circuit 22 includes a USB signal terminal 22a (D+, D−) and a power terminal 22b (V+, GND), which are electrically connected with the two USB signal traces 23 and 24 and the first DC trace 25 respectively. Referring to FIG. 4, the control circuit 22 is combined with a Bluetooth control chip having USB interface to have an antenna 221, a band pass filter 222, a TX balun 223, a USB Bluetooth control chip 224, a memory 225, and an LED indicator 226 electrically connected with the USB Bluetooth control chip 224, all of which are electrically interconnected. In this embodiment, the USB Bluetooth control chip 224 is an IC chip (No. BlueCore4) which is produced by CSR located in U.K. and whose required DC operation voltage is 3.3V. The antenna 221 is designed as a chip antenna for being conveniently received in the housing 10. Once received with driving voltage of 3.3V and USB signals, the control circuit 22 can provide the function of Bluetooth communication for the computer system.

To sum it up, when the computer interface card 1 is used in the notebook computer, i.e. the ExpressCard connector 201 is plugged into the ExpressCard slot of the notebook computer, the control circuit 22 can receive DC power supply of 3.3V from the notebook computer via the ExpressCard slot, the ExpressCard connector 201, and the first DC trace 25. Meanwhile, the control circuit 22 can communicate with USB host controller (not shown) of the computer system via the USB signal trace 23, the ExpressCard connector 201, and the ExpressCard slot of the notebook computer, thus enabling data exchange which is carried by USB signals between the control circuit 22 and a central processing unit (CPU; not shown) of the computer system. When the computer interface card 1 is used in the general computer system, i.e. the USB connector 202 is plugged into the USB port of the computer system, the DC power voltage of 5V provided by the USB port is transmitted to the converter 21 through the USB connector 202 and the second DC trace 26 to be converted into 3.3V and then provided for the control circuit 22 via the first DC trace 25. In the meantime, data exchange between the control circuit 22 and a central processing unit (CPU; not shown) of the computer system is carried by USB signals transmitted via the USB signal trace 24, the USB connector 202, and the USB port of the computer system. Accordingly, the computer interface card 1 can be broadly used in the general computer system having USB interface without additional card reader externally plugged in or internally built in the general computer system.

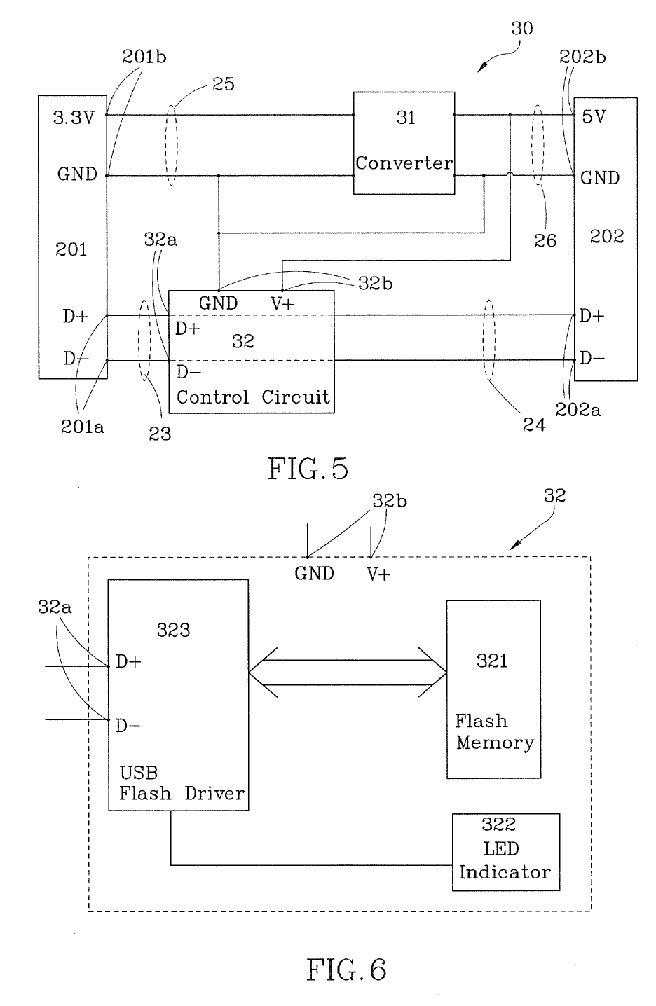

Referring to FIG. 5, a dual-interface computer interface card 2 constructed according to a second preferred embodiment of the present invention is similar to the first embodiment but different in the DC power application and connection of a circuit board 30 which is comprised of a converter 31 and a control circuit 32. The converter 31 functions as converting the voltage level (3.3V) of the first DC trace 25 into the voltage level (5V) of the second DC trace 26. In this embodiment, the converter 31 is a chip (No. LM2621) produced by National Semiconductor Corporation located in U.S.A.

The control circuit 32 also includes a USB signal terminal 32a (D+, D−) and a power terminal 32b (V+, GND) which are electrically connected with the two USB signal traces 23 and 24 and the second DC trace 26 respectively. Referring to FIG. 6, the control circuit 32 is combined with a mass storage IC having USB interface to have a flash memory 321, an LED indicator 322, and a USB flash driver 323, all of which are electrically interconnected. The USB flash driver 323 is an IC chip (No.UT161), which is produced by USBest Technology Inc. located in Taiwan and whose required DC operation voltage is 5V. The power source (not shown) of the flash memory 321 is supplied from the USB flash driver 323 and converted by a built-in voltage converter (not shown) of the USB flash driver 323. When driving voltage of 5V and USB signals are provided for the control circuit 32, the control circuit 32 can function as a USB mass storage device for the computer system.

In light of the above, when the computer interface card 2 is used in the notebook computer, i.e. the ExpressCard connector 201 is plugged into the ExpressCard slot of the notebook computer, the 3.3V DC power supplied by the ExpressCard slot is transmitted to the converter 31 through the ExpressCard connector 201 and the first DC trace 25 to be converted into 5V and then provided for the control circuit 32 via the second DC trace 26. In the meantime, the control circuit 32 can communicate with USB host controller (not shown) of the notebook computer through the USB signal trace 23, the ExpressCard connector 201, and the ExpressCard slot of the notebook computer, thus enabling data exchange which is carried by USB signals between the control circuit 32 and the CPU of the notebook computer. When the computer interface card 2 is used in the general computer system, i.e. the USB connector 202 is plugged into the USB port of the computer system, the control circuit 32 can receive 5V DC power provided by the USB port via the USB connector 202 and the second DC trace 26, and meanwhile, data exchange between the control circuit 32 and the CPU of the computer system is carried by USB signals transmitted through the USB signal trace 24, the USB connector 202, and the USB port of the computer system. Therefore, the computer interface card 2 can be widely applied to the general computer system having the USB interface without the additional card reader externally plugged in or internally built in the general computer system.

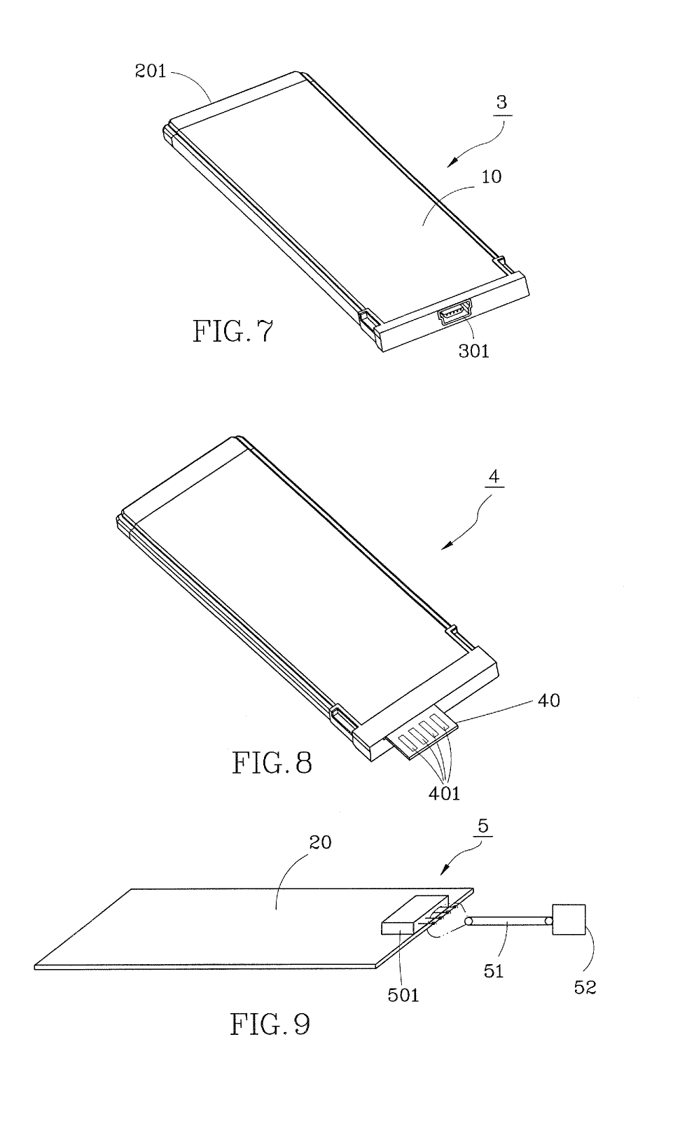

It is to be noted that the computer interface card of the present invention is not externally structurally limited to the housing with the connectors. When the computer interface card plugs into the ExpressCard slot of the notebook computer, referring to FIG. 1, the USB connector 202 of the computer interface card looks very protrusive. In this respect, referring to FIG. 7, a dual-interface computer interface card 3 constructed according to a third preferred embodiment of the present invention is similar to the aforementioned embodiments but different in that the computer interface card 3 includes a mini USB socket 301 instead of the USB connector 202, such that when the computer interface card 3 plugs into the ExpressCard slot of the notebook computer, the computer interface card 3 does not look protrusive all the time but only when the mini USB socket 301 is connected with the USB connection port of the computer system through a USB cable (not shown).

Referring to FIG. 8, a dual-interface computer interface card 4 constructed according to a fourth preferred embodiment of the present invention is similar to the first embodiment but different in that the computer interface card 4 includes a wiring connector 401, which is composed of USB interface (VSUB, GND, D+, D−) and is disposed on a circuit board 40, instead of the USB connector 202 of the first embodiment. The wiring connector 401 electrically functions the same as the USB connector 202 does. Accordingly, the module engineering for the USB plug or slot can be eliminated from the computer interface card 4 and the circuit space utilization of the circuit board can be more efficient.

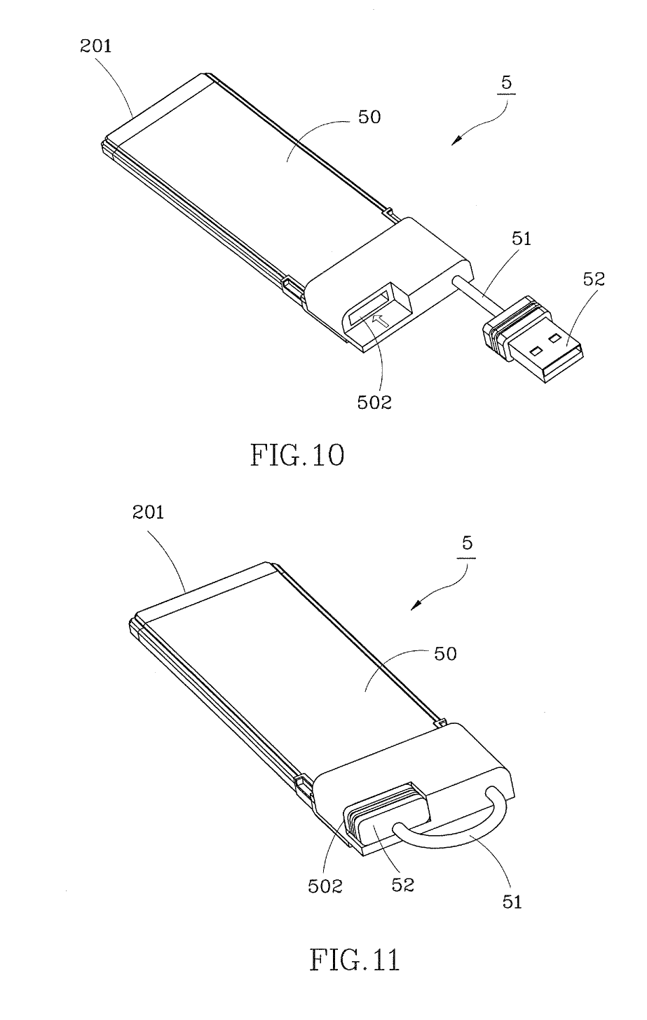

Referring to FIGS. 9-11, a dual-interface computer interface card 5 constructed according to a fifth preferred embodiment of the present invention is similar to the first embodiment but different in that the computer interface card 5 includes a USB terminal 501, which is composed of USB interface (VSUB, GND, D+, D−), instead of the USB connector 202 of the first embodiment and the circuit board 20 is mounted in a housing 50. The USB terminal 501 is mounted on the circuit board 20 and is electrically connected with a USB plug 52 through a cable 51. The cable 51 and the USB plug 52 are exposed outside the housing 50. The housing 50 further includes a reception 502 for receiving the USB plug 52.

When the computer interface card 5 is used in the notebook computer in such a way that the ExpressCard connector 201 plugs into the ExpressCard slot of the notebook computer, the USB plug 52 can be received into the reception 502 of the housing 50. When the computer interface card 5 is used in the general computer system, the USB plug 52 can be drawn out of the reception 502 and then inserted into the USB port of the computer system. Accordingly, the computer interface card 5 still has equivalent circuit function to those of the aforementioned embodiments and further considers the aesthetic appearance and safety, i.e. it prevents the USB plug 52 from exposure outside the housing 50 and damage incurred by accidental crash.

Although the present invention has been described with respect to specific preferred embodiments thereof, it is no way limited to the details of the illustrated structures but changes and modifications may be made within the scope of the appended claims.

What is claimed is:

1. A dual-interface computer interface card comprising:
a housing;
an ExpressCard connector;
a USB (universal serial bus) connector;
a circuit board mounted in said housing, said circuit board having two USB signal traces disposed thereon, a first DC (direct current) trace, and a second DC trace; said two USB signal traces being coupled with each other and electrically connected with said ExpressCard and USB connectors respectively, said first DC trace being electrically connected with said ExpressCard connector, said second DC trace being electrically connected with said USB connector;
a converter mounted on said circuit board and being electrically connected with said first and second DC traces for converting voltage level between said first DC trace and said second DC trace; and
a control circuit mounted on said circuit board and having a USB signal terminal and a power terminal, said USB signal terminal being electrically connected with said two USB signal traces, said power terminal being electrically connected with one of said first and second DC traces.

2. The computer interface card as defined in claim 1, wherein said USB connector is a USB plug.

3. The computer interface card as defined in claim 1, wherein said USB connector is a mini USB socket.

4. The computer interface card as defined in claim 1, wherein said USB connector is a wiring connector having a USB interface and disposed on said circuit board.

5. The computer interface card as defined in claim 4, wherein said wiring connector is exposed outside said housing.

6. The computer interface card as defined in claim 1, wherein said USB connector is a USB terminal having a USB interface and electrically connected with a USB plug through a cable, said cable and said USB plug being exposed outside said housing.

7. The computer interface card as defined in claim 6, wherein said housing further comprises a reception for receiving said USB plug.
